(19) United States
(12) Patent Application Publication
(10) Pub. No.: US 2020/0117056 A1
(43) Pub. Date: Apr. 16, 2020

(54) DISPLAY DEVICE

(71) Applicant: Samsung Display Co., Ltd., Yongin-si (KR)

(72) Inventor: Byung-Seo YOON, Hwaseong-si (KR)

(21) Appl. No.: 16/504,864

(22) Filed: Jul. 8, 2019

(30) Foreign Application Priority Data
Oct. 11, 2018 (KR) 10-2018-0120982

(51) Int. Cl. G02F 1/1335

(52) U.S. Cl. CPC G02F 1/133608; G02F 1/133605

(57) ABSTRACT

A display device includes a display panel, a light source substrate below the display panel, a plurality of light source units on the light source substrate, an optical member between the display panel and the light source substrate, and a plurality of support members between the optical member and the light source substrate. Each of the plurality of support members includes a first support pillar configured to support the optical member, a plurality of second support pillars configured to be connected to the light source substrate, and a plurality of connection parts configured to connect the first support pillar to the second support pillars.

### CROSS-REFERENCE TO RELATED APPLICATION

This patent application claims priority to and the benefit of Korean Patent Application No. 10-2018-0120982, filed on Oct. 11, 2018, the entire content of which is hereby incorporated by reference.

### BACKGROUND

The present disclosure herein relates to a display device, and more particularly, to a display device that is capable of firmly supporting an optical member.

A display device including a non-emission display panel, such as a liquid crystal display panel, among display devices may further include a backlight unit providing light to the display panel. The backlight unit generates light to provide the generated light to the display panel. The display panel displays an image by using the light provided from the backlight unit.

The backlight unit may be an edge type backlight unit (e.g., an edge backlight unit) disposed (located) on one side (e.g., an edge) of the display panel to generate light and/or a direct type backlight unit (e.g., a direct backlight unit) disposed under the display panel to generate light. The direct type backlight unit includes an optical member and a light source disposed below the optical member. Light generated in the light source is provided to the optical member, and the optical member improves uniformity in luminance of the light so as to provide the light having uniform luminance to the display panel.

The light source in the direct type backlight unit is disposed to be spaced apart from the optical member. An edge of the optical member is disposed on a bottom chassis, for example. A structure for supporting the optical member to maintain a constant interval between the light source and the optical member, except for the edge portion of the optical member, is required or desired.

### SUMMARY

One or more aspects of embodiments of the present disclosure are directed toward a display device that is capable of more firmly supporting an optical member than a comparable display device.

An embodiment of the inventive concept provides a display device including: a display panel; a light source substrate below the display panel; a plurality of light source units on the light source substrate; an optical member between the display panel and the light source substrate; and a plurality of support members between the optical member and the light source substrate, wherein each support member of the plurality of support members includes: a first support pillar configured to support the optical member; a plurality of second support pillars configured to be connected to the light source substrate; and a connection part configured to connect the first support pillar to the plurality of second support pillars.

In an embodiment of the inventive concept, a display device includes: a display panel; a light source substrate below the display panel; a plurality of light source units on the light source substrate; an optical member between the display panel and the light source substrate; and a plurality of support members between the optical member and the light source substrate, wherein each support member of the plurality of support members includes: a plurality of support pillars configured to support the optical member; and a plurality of connection parts configured to connect the plurality of support pillars to each other, wherein a lower portion of each support pillar of the plurality of support pillars is configured to be inserted into a corresponding first hole of a plurality of first holes defined in the light source substrate.

### BRIEF DESCRIPTION OF THE FIGURES

The accompanying drawings are included to provide a further understanding of the inventive concept, and are incorporated in and constitute a part of this specification. The drawings illustrate example embodiments of the inventive concept and, together with the description, serve to explain principles of the inventive concept. In the drawings:

FIG. 1 is an exploded perspective view of a display device according to an embodiment of the inventive concept;

FIG. 2 is a view illustrating a configuration of one pixel disposed on a display panel of FIG. 1;

FIG. 3 is a cross-sectional view taken along line I-I′ of FIG. 1;

FIG. 4 is an enlarged view illustrating one support member of FIG. 1;

FIG. 5 is an enlarged plan view of a light source substrate to which the support member of FIG. 4 is connected;

FIG. 6 is a cross-sectional view taken along line II-II′ of FIG. 5; and

FIGS. 7-12 are views illustrating support members according to various embodiments of the inventive concept.

### DETAILED DESCRIPTION

In this specification, it will be understood that when one component (or region, layer, and/or portion) is referred to as being cony, ‘connected to’, or ‘coupled to’ another component, it can be directly on/connected to/coupled to the other component (or region, layer, and/or portion), or one or more intervening components may also be present. When a component is referred to as being “directly on,” “directly connected to,” or “directly coupled to” another component, there are no intervening components present.

Like reference numerals refer to like elements throughout the specification and drawings. Also, in the figures, the thickness, ratio, and dimensions of components are exaggerated for clarity of illustration.

The term “and/or” includes any and all combinations of one or more of the associated listed items. Expressions such as “at least one of,” “one of,” and “selected from,” when preceding a list of elements, modify the entire list of elements and do not modify the individual elements of the list. Further, the use of “may” when describing embodiments of the present invention refers to “one or more embodiments of the present invention.”

It will be understood that although the terms such as ‘first’ and ‘second’ are used herein to describe various elements, these elements should not be limited by these terms. The terms are only used to distinguish one component from other components. For example, a first element referred to as a first element in one embodiment can be referred to as a second element in another embodiment without departing from the scope of the appended claims. The terms of a singular form may include plural forms unless the context indicates otherwise.

Also, “under”, “below”, “above”, “upper”, and/or the like terms are used for explaining relation association of components illustrated in the drawings. The terms may be a relative concept and described based on directions expressed in the drawings.

Unless otherwise defined, all terms (including technical and scientific terms) used herein have the same meaning as commonly understood by a person of ordinary skill in the art to which this invention belongs. Also, terms such as defined terms in commonly used dictionaries are to be interpreted as having meanings consistent with meaning in the context of the relevant art and are expressly defined herein unless interpreted in an ideal or overly formal sense.

The meaning of ‘include’ or ‘comprise’ as used herein specifies a property, a fixed number, a step, an operation, an element, a component or a combination thereof, but does not exclude other properties, fixed numbers, steps, operations, elements, components or combinations thereof.

Hereinafter, embodiments of the inventive concept will be described in more detail with reference to the accompanying drawings.

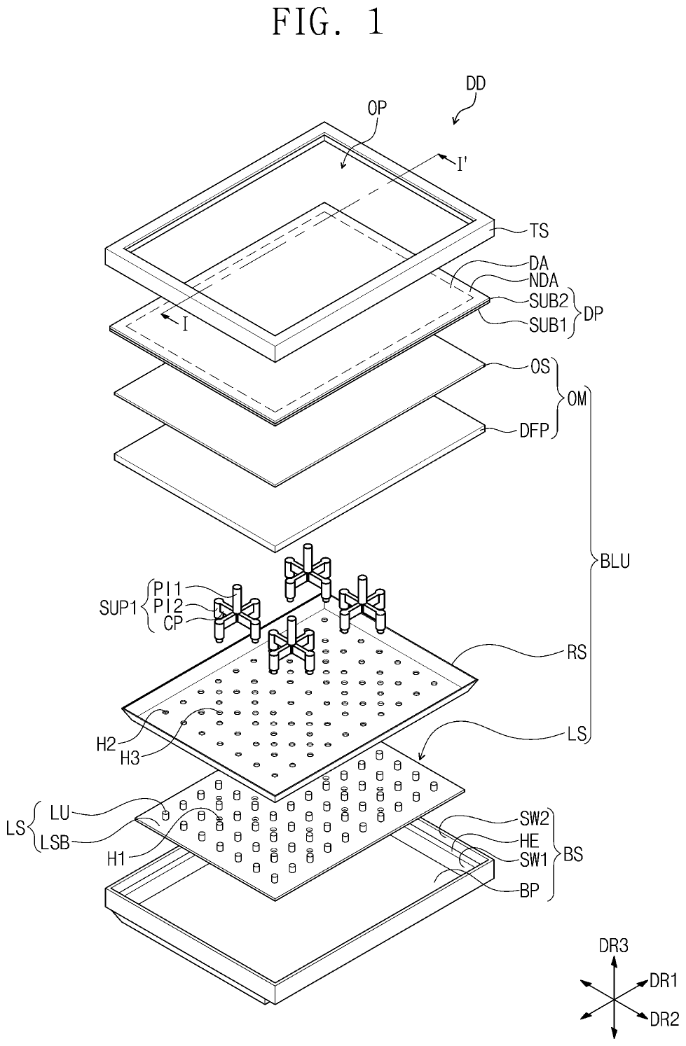

FIG. 1 is an exploded perspective view of a display device according to an embodiment of the inventive concept.

Referring to FIG. 1, a display device DD according to an embodiment of the inventive concept may include a display panel DP, a backlight unit BLU, and first and second protection members BS and TS. Each of the display panel DP and the backlight unit BLU has long sides extending in a first direction DR1 and short sides extending in a second direction DR2 crossing the first direction DR1.

Various display panels that are capable of displaying an image such as, for example, a liquid crystal display panel, an electrophoretic display panel, and/or an electrowetting display panel may be used as the display panel DP. For example, the display panel DP may be a liquid crystal display panel.

The display panel DP may include a first substrate SUB1, a second substrate SUB2 disposed to face the first substrate SUB1, and a liquid crystal layer disposed between the first substrate SUB1 and the second substrate SUB2. Liquid crystal molecules of the liquid crystal layer adjust transmittance of light so that an image can be displayed.

The display panel DP may have a plane (e.g., the display panel DP may lie in a plane) defined by the first and second directions DR1 and DR2. Hereinafter, a direction normal to (e.g., perpendicularly crossing) the plane defined by the first and second directions DR1 and DR2 is defined as a third direction DR3. In this specification, “when viewed in a plane” may refer to a state viewed in the third direction DR3, for example, a state in which the display panel DP is viewed from an upper side thereof.

The plane of the display panel DP may include a display area DA on which an image is displayed and a non-display area NDA surrounding the display area DA. A plurality of pixels for displaying an image may be disposed on the display area DA. An image may not be displayed on the non-display area. Driving units for driving the pixels may be disposed on the non-display area NDA.

The backlight unit BLU may be disposed below the display panel DP to provide light to the display panel DP. The pixels of the display panel DP may display an image by using the light provided from the backlight unit BLU. The first and second protection members BS and TS may accommodate and protect the backlight unit BLU and the display panel DP.

The backlight unit may include an optical member OM, a light source LS, a reflection sheet RS, and a plurality of support members SUP1. The light source LS may be disposed below the display panel DP, and the optical member OM may be disposed between the display panel DP and the light source LS. The support members SUP1 may be disposed between the optical member OM and the light source LS and may be connected to the light source LS to support the optical member OM.

The optical member OM may include an optical sheet OS disposed below the display panel DP and a diffusion plate DFP disposed below the optical sheet OS. The diffusion plate DFP may be a structure that is harder than the optical sheet OS. In some embodiments, the diffusion plate DFP may be omitted.

The diffusion plate DFP may receive the light generated in the light source LS and may diffuse the received light. A diffusion agent may be distributed in the diffusion plate DFP, and/or a diffusion film may be applied to a surface of the diffusion plate DFP, without limitation. The light diffused in the diffusion plate DFP may be provided to the optical sheet OS.

The optical sheet OS may collect the light diffused by the diffusion plate DFP and may provide the collected light to the display panel DP. In some embodiments, the optical sheet OS may include a diffusion sheet, a prism sheet disposed on the diffusion sheet, and a protection sheet disposed on the prism sheet.

The diffusion sheet may diffuse (or further diffuse) the light provided from the diffusion plate DFP. The prism sheet may collect the light diffused by the diffusion sheet in a third direction DR3. The light passing through the prism sheet may vertically travel upward. As a result, light having uniform luminance distribution may be provided to the display panel DP. The protection sheet may protect the prism sheet that may be weak against scratches.

The reflection sheet RS may be disposed below the diffusion plate DFP. The light source LS may be disposed below the reflection sheet RS. The light source LS may include a light source substrate LSB and a plurality of light source units LU mounted on the light source substrate LSB to generate light.

The light source substrate LSB may have a rectangular shape with long sides extending in the first direction DR1 and short sides extending in the second direction DR2. For example, the light source units LU may be arranged in the form of a matrix, but the arrangement shape of the light source units LU is not limited thereto. The light source units LU may be light emitting diodes. The light generated in the light source units LU may be provided to the diffusion plate DFP.

A plurality of first holes H1 may be defined in the light source substrate LSB. A plurality of second holes H2, overlapping the light source units LU, and a plurality of third holes H3, overlapping the first holes H1, may be defined in the reflection sheet RS. The light source units LU may be inserted into the second holes H2. The reflection sheet RS may reflect the light emitted laterally backward from the light source units LU and may provide the reflected light to the diffusion plate DFP.

Lower portions (e.g., lower regions) of the support members SUP1 may pass through the third holes H3 and then be inserted into the first holes H1. The lower portions of the support members SUP1 may be inserted into the first holes H1 and may be connected to the light source substrate LSB to support the optical member OM.

Although in the embodiment of FIG. 1, the support members SUP1 support the diffusion plate DFP, if the diffusion plate DFP is omitted, the support members SUP1 may support the optical sheet OS. Although four support members SUP1 are illustrated in the embodiment of FIG. 1 as an example, the number of support members SUP1 is not limited thereto.

Each of the support members SUP1 may include a first support pillar PI1 extending in the third direction DR3, a plurality of second support pillars PI2 spaced apart from the first support pillar PI1 to extend in the third direction DR3, and a plurality of connection parts CP1 connecting the first support pillar PI1 to the second support pillars P12. Although four second support pillars PI2 are illustrated in the embodiment of FIG. 1 as an example, the number of second support pillars PI2 is not limited thereto.

The first support pillar PI1 may support the optical member OM, and the second support pillars PI2 may be connected to the light source substrate LSB. For example, lower portions of the second support pillars PI2 may pass through the third holes H3 and then be inserted into the first holes H1 to be connected to the light source substrate LSB. Hereinafter, the above-described constitutions will be described in more detail.

The first protection member BS may be defined as a bottom chassis. The second protection member TS may be defined as a top chassis. The first protection member BS may be disposed below the backlight unit BLU, and the second protection member TS may be disposed on (above) the display panel DP.

The first protection member BS may include a bottom part BP, a first sidewall SW1, a horizontal extension part HE, and a second sidewall SW2. The bottom part BP has a rectangular shape having long sides in a first direction DR1 and short sides in a second direction DR2.

The first sidewall SW1 may extend upward from a boundary of the bottom part BP. The first sidewall SW1 may have an inclined surface that is angled at a predetermined (or set) angle with respect to the bottom part BP and is bent upward. The horizontal extension part HE may extend from an upper end (edge) of the first sidewall SW1 in a direction parallel to the bottom part BP. The second sidewall SW2 may extend from a boundary of the horizontal extension part HE in a direction perpendicular to the horizontal extension part HE.

The second protection member TS may have a frame shape (e.g., a rectangular shape with an opening in the middle), and an opening OP, through which the display area DA of the display panel DP is exposed, may be defined in the second protection member TS.

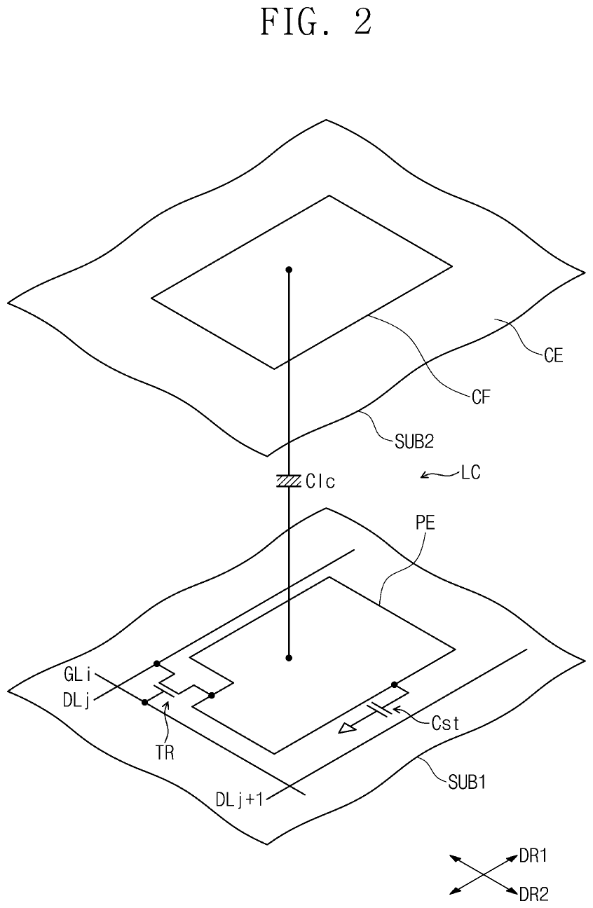

FIG. 2 is a view illustrating a configuration of one pixel disposed on a display panel of FIG. 1.

Referring to FIG. 2, the pixel PX may include a transistor TR connected to the gate line GLi and the data line DLj, a liquid crystal capacitor Clc connected to the transistor TR, and a storage capacitor Cst parallelly connected to the liquid crystal capacitor Clc. In some embodiments, the storage capacitor Cst may be omitted. Here, i and j are natural numbers.

The transistor TR may be disposed on the first substrate SUB1. The transistor TR may include a gate electrode connected to the gate line GLi, a source electrode connected to the data line DLj, and a drain electrode connected to the liquid crystal capacitor Clc and the storage capacitor Cst.

The liquid crystal capacitor Clc may include a pixel electrode PE disposed on the first substrate SUB1, a common electrode CE disposed on the second substrate SUB2, and the liquid crystal layer LC disposed between the pixel electrode PE and the common electrode CE. The liquid crystal layer LC may serve as a dielectric. The pixel electrode PE may be connected to the drain electrode of the transistor TR.

Although the pixel electrode PE has a non-slit structure in FIG. 2, the embodiment of the inventive concept is not limited thereto. For example, the pixel electrode PE may have a slit structure including a stem part having a cross shape and a plurality of branch parts radially extending from the stem part.

The common electrode CE may be disposed over an entire lower portion of the second substrate SUB2 (e.g., the portion of the second substrate SUB2 facing the first substrate SUB1). However, the embodiment of the inventive concept is not limited thereto. For example, the common electrode CE may be disposed on the first substrate SUB1. In this case, at least one of the pixel electrode PE and the common electrode CE may have a slit.

The storage capacitor Cst may include the pixel electrode PE, a storage electrode that is branched from a storage line, and an insulation layer disposed between the pixel electrode PE and the storage electrode. The storage line may be disposed on the first substrate SUB1. Also, the storage line and the gate lines GLi to GLm may be formed on the same layer at the same time. The storage electrode may partially overlap the pixel electrode PE.

The pixel PX may further include a color filter CF for representing one of red, green, and blue colors. As an example embodiment, the color filter CF may be disposed on the second substrate SUB2 as illustrated in FIG. 2. However, the embodiment of the inventive concept is not limited thereto. For example, the color filter CF may be disposed on the first substrate SUB1.

The transistor TR may be turned on in response to a gate signal provided through the gate line GLi. A data voltage received through the data line DLj may be provided to the pixel electrode PE of the liquid crystal capacitor Clc through the transistor TR that is turned on. A common voltage may be applied to the common electrode CE.

Electric fields may be generated between the pixel electrode PE and the common electrode CE by a difference in voltage level between the data voltage and the common voltage. Liquid crystal molecules of the liquid crystal layer LC may operate (e.g., be aligned) by the electric fields generated between the pixel electrode PE and the common electrode CE. Light transmittance may be adjusted by the liquid crystal molecules that operate (e.g., are aligned) by the electric field to display an image.

A storage voltage having a uniform voltage level may be applied to the storage line. However, the embodiment of the inventive concept is not limited thereto. For example, the common voltage may be applied to the storage line. The storage capacitor Cst may serve to compensate a charged amount of liquid crystal capacitor Clc.

FIG. 3 is a cross-sectional view taken along line I-I′ of FIG. 1.

Referring to FIG. 3, the light source substrate LSB may be disposed on the bottom part BP. The light source units LU may be inserted into the second holes H2 of the reflection sheet RS, and the reflection sheet RS may be disposed on the light source substrate LSB. In some embodiments, the reflection sheet RS may also be disposed on the first sidewall SW1 (e.g., to extend along the first sidewall SW1).

The diffusion plate DFP may be disposed on the reflection sheet RS, and the edge of the diffusion plate DFP may be disposed on the horizontal extension part HE. Since the edge of the diffusion plate DFP is disposed on the horizontal extension part HE, a predetermined (or set) space may be defined between the diffusion plate DFP and the bottom part BP. Thus, the light source units LU may be spaced apart from the diffusion plate DFP.

Side surfaces of the diffusion plate DFP and the optical sheet OS may be disposed adjacent to an inner surface of the second sidewall SW2. A top surface of the optical sheet OS may be disposed at the same height as a top surface of the second sidewall SW2. The display panel DP may be disposed on the optical sheet OS and the second sidewall SW2.

The second protection member TS may be disposed to cover the non-display area NDA of the display panel DP. The display area DA of the display panel DP may be exposed through the opening OP. The second protection member TS may include a third sidewall SW3 extending in the third direction DR3 and disposed adjacent to an outer surface of the second sidewall SW2.

The first support pillar PI1 may contact the bottom surface of the diffusion plate DFP to support the optical member OM. The lower portions of the second support pillars PI2 may be connected to the light source substrate LSB. The second support pillars PI2 may be spaced apart from the optical member OM, and the connection parts CP1 may be spaced apart from the optical member OM and the light source substrate LSB.

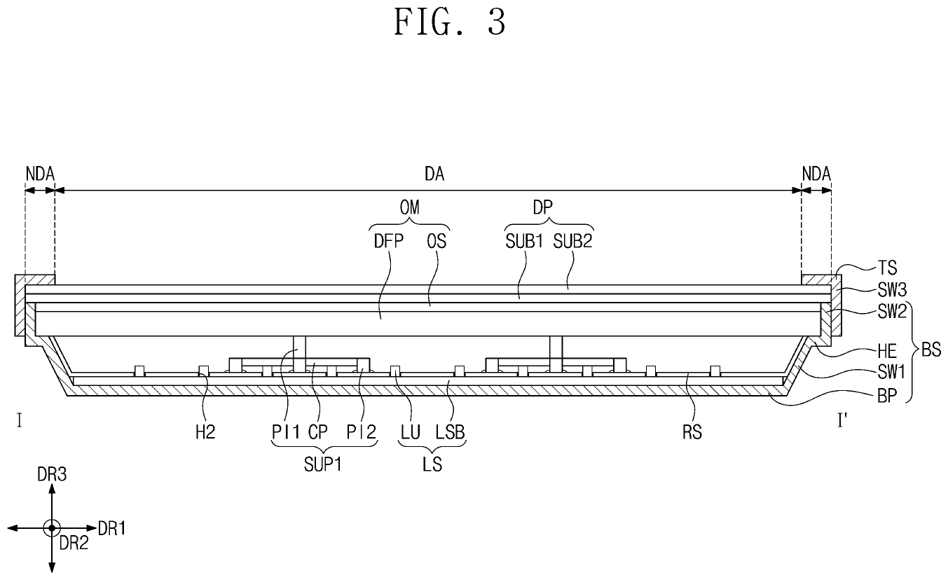

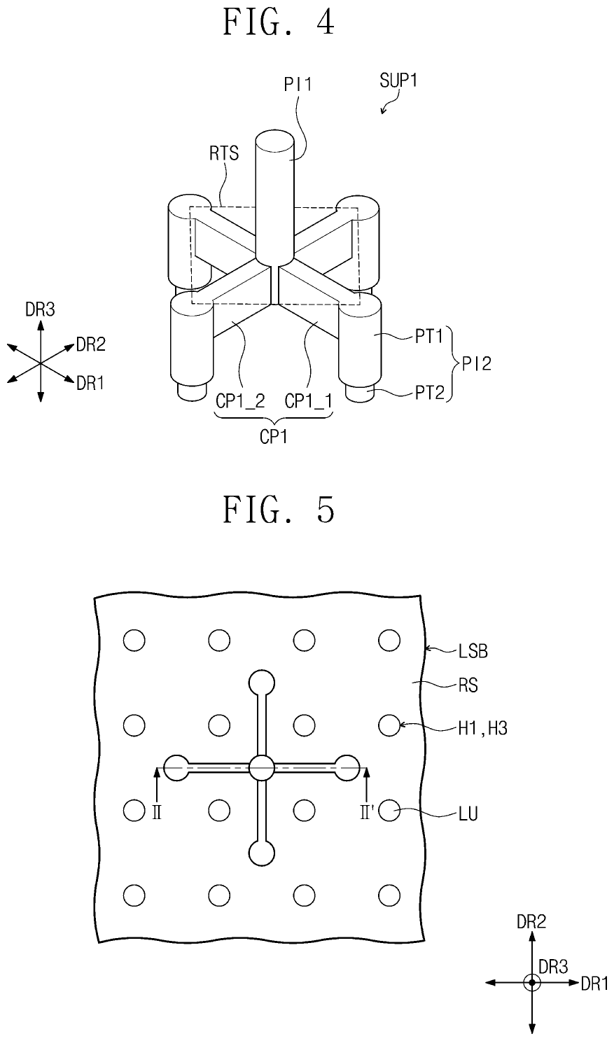

FIG. 4 is an enlarged view illustrating one support member of FIG. 1.

Referring to FIG. 4, each of the first and second support pillars PI1 and PI2 may have a cylindrical shape extending in the third direction DR3. For example, each of the first and second support pillars PI1 and PI2 may have a diameter of about 0.5 mm to about 1.5 mm, for example, about 1 mm.

The second support pillars PI2 may be spaced apart from the first support pillar PI1 in a direction parallel to the plane defined by the first and second directions DR1 and DR2. The connection parts CP1 may extend in a horizontal direction (e.g., parallel to the plane defined by the first and second directions DR1 and DR2) and may be connected to the lower portion of the first support pillar PI1 and the upper portion of each of the second support pillars P12. Each of the connection parts CP1 may have a rectangular shape with long sides extending in the second direction (or the first direction) and short sides extending in the third direction DR3.

When viewed in the plane, the second support pillars PI2 may be disposed at vertexes of the rectangular shape RTS, respectively. The first support pillar PI1 may be disposed at a central portion of the rectangular shape RTS.

The connection parts CP1 may include a first connection part CP1_1 extending in the first direction DR1 and a second connection part CP1_2 extending in the second direction DR2 to cross the first connection part CP1_1. The first support pillar PI1 may be connected to a crossing point between the first connection part CP1_1 and the second connection part CP1_2. The second support pillars PI2 may be respectively connected to ends of the first and second connection parts CP1_1 and CP1_2.

Each of the second support pillars PI2 may include a first portion PT1 and a second portion PT2 protruding downward (in the third direction DR3) from a lower portion of the first portion PT1. The first portions PT1 may be connected to the respective ends of the connection parts CP1. The second portions PT2 may define lower portions of the second support pillars P12.

When viewed in the plane, each of the portions PT1 may be greater in diameter than each of the second portions PT2. A diameter of each of the second support pillars PI2 may be substantially the diameter of each of the first portions PT1. Each of the second portions PT2 may have a diameter less than that of each of the first portions PT1.

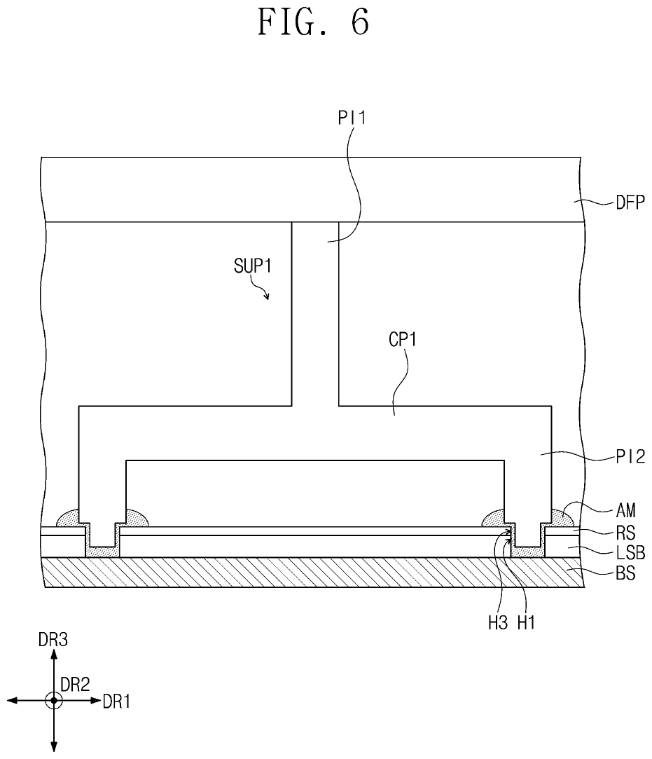

FIG. 5 is an enlarged plan view of the light source substrate to which the support member of FIG. 4 is connected. FIG. 6 is a cross-sectional view taken along line II-II′ of FIG. 5.

Referring to FIG. 5, the light source units LU may be arranged in the form of a matrix, but the embodiment of the inventive concept is not limited to this arrangement shape of the light source units LU. When viewed in the plane, the support member SUP1 may not overlap the light source units LU. For example, the first and second support pillars PI1 and PI2 and the connection parts CP1 may not overlap the light source units LU. For example, the second support pillars PI2 may be disposed between the light source units LU and connected to the light source substrate LSB.

Referring to FIG. 6, the reflection sheet RS may be disposed on the light source substrate LSB, and the third holes H3 defined in the reflection sheet RS may overlap the first holes H1 defined in the light source substrate LSB. The display device DD may further include adhesion members AM disposed on the first holes H1 and the third holds H3.

The lower portions of the second support pillars PI2 may pass through the third holes H3 and then be inserted into the first holes H1. The lower portions of the second support pillars PI2 may be connected to the light source substrate LSB by using the adhesion members AM.

For example, the second portions PT2 of the second support pillars PI2 may pass through the third holes H3 and then be inserted into the first holes H1. The second portions PT2 may be connected to the light source substrate LSB by using the adhesion members AM. The adhesion member AM may include an epoxy adhesive.

The non-cured adhesion members AM may be disposed first on (and/or in) the first and third holes H1 and H3, and then, the second portions PT2 may be inserted into the first and third holes H1 and H3. Thereafter, the adhesion members AM may be cured, and the second portions PT2 may be fixed by the cured adhesion members AM.

When the second portions PT2 are inserted into the first and third holes H1 and H3, the non-cured adhesion members AM may overflow from the first and third holes H1 and H3. Thus, the adhesion members AM disposed on (and/or in) the first and third holes H1 and H3 may cover portions (e.g., regions) of the reflection sheet RS adjacent to the third holes H3, and the lower portions of the first portions PT1. For example, the adhesion member AM disposed on the reflection sheet RS may have a width of about 2 mm to about 4 mm. The width may be a numerical value measured in the horizontal direction (e.g., first direction DR1 and/or second direction DR2).

When compared to a case in which the adhesion member AM is disposed on only the first holes H1 or the first and third holds H1 and H3, if the adhesion member AM also covers the portion of the reflection sheet RS adjacent to the third holes H3 and the lower portions of the first portions PT1, the second support pillars P12 may be more firmly fixed to the light source substrate LSB.

When viewed in the plane, each of the first portions PT1 may have a size (e.g., diameter) greater than that of each of the first and third holes H1 and H3. Each of the second portions PT2 may have a size (e.g., diameter) less than that of each of the first and third holes H1 and H3. Thus, the first portions may not be inserted into the first and third holes H1 and H3, and the second portions PT2 may be easily inserted into the first and third holes H1 and H3.

The first support pillar PI1 may be spaced apart from the light source substrate LSB to support the optical member OM. When upper ends of the first support pillar PI1 contact the bottom surface of the diffusion plate DFP, the first support pillars PI1 may support the optical member OM.

For example, the first and second support pillars PI1 and PI2 and the connection parts CP1 may be integrated with each other. However, the embodiment of the inventive concept is not limited thereto. For example, the first support pillar PI1, and the second support pillar PI2, and the connection parts CP1 may be separately manufactured and then coupled to each other.

In an embodiment of the inventive concept, the second support pillars PI2 may be provided in plurality on the light source substrate LSB so as to be firmly fixed to the light source substrate LSB. Thus, since the second support pillars PI2 providing a support base of the support members SUP1 are more firmly fixed to the light source substrate LSB, the first support pillar PI1 may more stably support the optical member OM.

As a result, the display device DD according to an embodiment of the inventive concept may more firmly support the optical member OM.

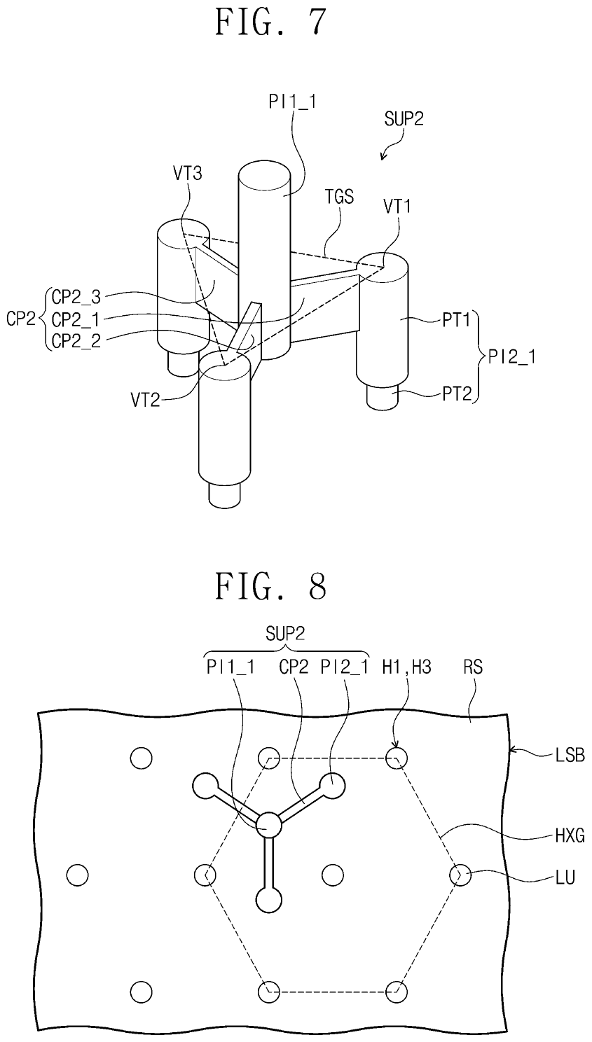

FIGS. 7 to 12 are views illustrating support members according to various embodiments of the inventive concept.

The structure in which support members SUP2 to SUP6 are fixed to the light source substrate LSB may be substantially the same as that described with reference to FIGS. 1 to 6. Thus, constituents of the support members SUP2 to SUP6 that are different from those of the support member SUP1 will be mainly described with reference to FIGS. 7 to 12.

Referring to FIGS. 7 and 8, the support member SUP2 may include a first support pillar PI1_1, a plurality of second support pillars PI2_1, and a plurality of connection parts CP2. The first support pillar PI1_1 may be the same as the first support pillar PI1 of FIG. 4.

Each of the second support pillars PI2_1 may be substantially the same as each of the second support pillars PI2 of FIG. 4. For example, each of the second support pillars PI2_1 may include a first portion PT1 and a second portion PT2, like the second support pillars P12.

The first support pillar PI1_1 may be disposed at a central portion of a triangular shape TGS. The second support pillars PI2_1 may be disposed at vertexes VT1, VT2, and VT3 of the triangular shape TGS, respectively. The first support pillar PI1_1 may support the optical member OM, and the second support pillars PI2_1 may be connected to the light source substrate LSB by the adhesion members AM.

The connection parts CP2 may include a first connection part CP2_1, a second connection part CP2_2, and a third connection part CP2_3. The first connection part CP2_1 may extend from the central portion of the triangular shape TGS to the first vertex VT1 of the triangular shape TGS. The second connection part CP2_2 may extend from the central portion of the triangular shape TGS to the second vertex VT2 of the triangular shape TGS. The third connection part CP2_3 may extend from the central portion of the triangular shape TGS to the third vertex VT3 of the triangular shape TGS.

The first support pillar PI1_1 may be disposed at the central portion of the triangular shape TGS and may be connected to the first, second, and third connection parts CP2_1, CP2_2, and CP2_3. The second support pillar PI2_1 may be disposed at the first, second, and third vertexes VT1, VT2, and VT3 and may be connected to the first, second, and third connection parts CP2_1, CP2_2, and CP2_3, respectively.

As illustrated in FIG. 8, the light source units LU may be disposed at vertexes of a hexagonal shape HXG. The first and second support pillars PI1_1 and PI2_1 and the connection parts CP2 (e.g., the third connection part CP2_3) may not overlap the light source units LU when viewed in the plane. Thus, the second support pillars PI2_1 may be disposed between the light source units LU when viewed in the plane.

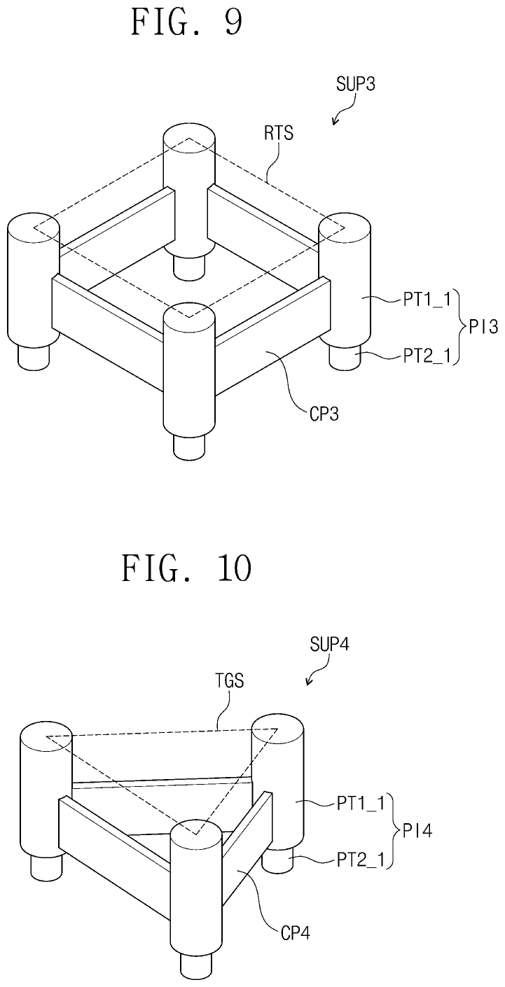

Referring to FIG. 9, the support member SUP3 may include a plurality of support pillars PI3 and a plurality of connection parts CP3 connecting the support pillars PI3 to each other. When viewed in the plane, the support pillars PI3 may be respectively disposed at vertexes of a rectangular shape RTS, and the connection parts CP3 may be respectively disposed on four sides of the rectangular shape RTS.

The support pillars PI3 may be connected to the light source substrate LSB to support the optical member OM. For example, each of the support pillars PI3 may include a first portion PT1_1 and a second portion PT2_1 protruding downward (e.g., toward the light source substrate LSB) from a lower portion of the first portion PT1_1. The first portions PT1_1 may support the optical member OM of FIG. 5. Also, the second portions PT2_1 may be inserted into the first and third holes H1 and H3 of FIG. 5 and may be connected to the light source substrate LSB by the adhesion members AM.

In the support member SUP1 of FIG. 4, one first support pillar PI1 may support the optical member OM. However, in the support member SUP3 of FIG. 9, the plurality of support pillars PI3 may support the optical member OM.

Referring to FIG. 10, the support member SUP4 may include a plurality of support pillars PI4 and a plurality of connection parts CP4 connecting the support pillars PI4 to each other. Each of the support pillars PI4 may be the same as each of the support pillars PI3 of FIG. 9. For example, each of the support pillars PI4 may include a first portion PT1_1 and a second portion PT2_1, like the support pillars P13.

When viewed in the plane, the support pillars PI4 may be respectively disposed at vertexes of a triangular shape TGS, and the connection parts CP4 may be respectively disposed on three sides of the triangular shape TGS.

The support pillars PI4 may be connected to the light source substrate LSB to support the optical member OM. For example, the first portions PT1_1 of the support pillars PI4 may support the optical member OM of FIG. 5, and the second portions PT2_1 of the support pillars PI4 may be inserted into the first and third holes H1 and H3 of FIG. 5 and connected to the light source substrate LSB by the adhesion members AM.

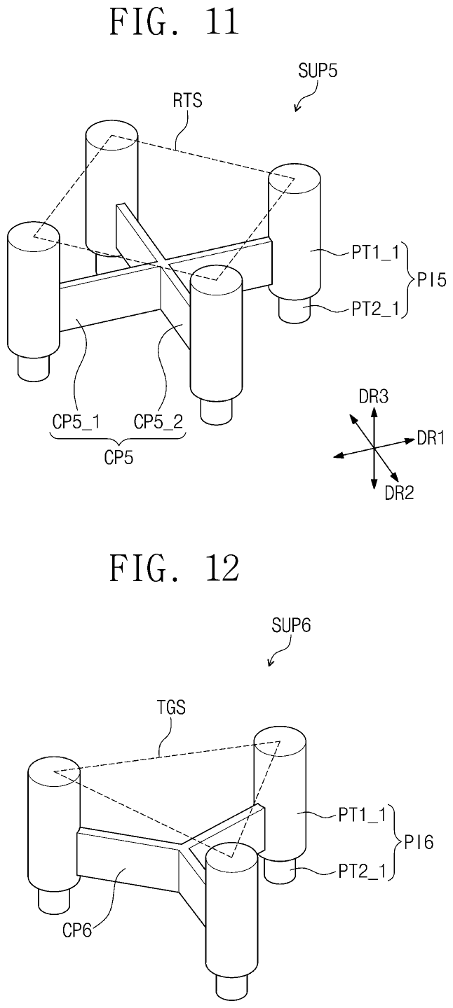

Referring to FIG. 11, the support member SUP5 may include a plurality of support pillars PI5 and a plurality of connection parts CP5 connecting the support pillars PI5 to each other. When viewed in the plane, the support pillars PI5 may be disposed at vertexes of the rectangular shape RTS, respectively. Each of the support pillars PI5 may be substantially the same as each of the support pillars PI3 of FIG. 9.

The connection parts CP5 may include a first connection part CP5_1 extending in the first direction DR1 and a second connection part CP5_2 extending in the second direction DR2 to cross the first connection part CP5_1. The support pillars PI5 may be connected to ends of each of the first and second connection parts CP5_1 and CP5_2.

For example, the first portions PT1_1 of the support pillars PI5 may support the optical member OM of FIG. 5, and the second portions PT2_1 of the support pillars PI5 may be connected to the light source substrate LSB of FIG. 5.

Referring to FIG. 12, the support member SUP6 may include a plurality of support pillars PI6 and a plurality of connection parts CP6 connecting the support pillars PI6 to each other. Each of the support pillars PI6 may be substantially the same as each of the support pillars PI4 of FIG. 10.

The support pillars PI6 may be disposed at vertexes of the triangular shape TGS, respectively. The connection parts CP6 may extend from a central portion of the triangular shape toward each of the vertexes and then be connected to the support pillars P16, respectively. The first portions PT1_1 of the support pillars PI6 may support the optical member OM of FIG. 5, and the second portions PT2_1 of the support pillars PI6 may be connected to the light source substrate LSB of FIG. 5.

According to the embodiment of the inventive concept, since the plurality of second support pillars, which provide the support base of the support members, are more firmly fixed to the light source substrate, the first support pillar may more stably support the optical member. Therefore, the display device may more firmly support the optical member.

As used herein, the terms “use,” “using,” and “used” may be considered synonymous with the terms “utilize,” “utilizing,” and “utilized,” respectively.

In addition, the terms “substantially,” “about,” and similar terms are used as terms of approximation and not as terms of degree, and are intended to account for the inherent deviations in measured or calculated values that would be recognized by those of ordinary skill in the art.

Also, any numerical range recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

It will be apparent to those skilled in the art that various modifications and variations can be made in the inventive concept. Thus, it is intended that the present disclosure covers the modifications and variations of this invention provided they come within the scope of the appended claims and their equivalents. Thus, to the maximum extent allowed by law, the scope of the present invention is to be determined by the broadest permissible interpretation of the following claims and their equivalents, and shall not be restricted or limited by the foregoing detailed description.

What is claimed is:

1. A display device comprising:
a display panel;
a light source substrate below the display panel;
a plurality of light source units on the light source substrate;
an optical member between the display panel and the light source substrate; and
a plurality of support members between the optical member and the light source substrate,
wherein each of the plurality of support members comprises:
a first support pillar configured to support the optical member;
a plurality of second support pillars configured to be connected to the light source substrate; and
a connection part configured to connect the first support pillar to the plurality of second support pillars.

2. The display device of claim 1, wherein the first support pillar is spaced apart from the light source substrate, and
the plurality of second support pillars are spaced apart from the optical member.

3. The display device of claim 1, wherein the plurality of light source units are arranged in a matrix form, and
the plurality of second support pillars are between the plurality of light source units when viewed in a thickness direction of the display device.

4. The display device of claim 1, wherein the display panel lies in a plane defined by a first direction and a second direction crossing the first direction, and
the first support pillar and each second support pillar of the plurality of second support pillars extend in a third direction normal to the plane of the display panel.

5. The display device of claim 4, wherein each second support pillar of the plurality of second support pillars is spaced apart from the first support pillar in a direction parallel to the plane, and
the connection part extends in the direction parallel to the plane and is configured to be connected to a lower portion of the first support pillar and upper portions of the plurality of second support pillars.

6. The display device of claim 4, wherein, when viewed in the plane, the plurality of second support pillars are respectively arranged at vertexes of a rectangular shape, and
the first support pillar is at a central portion of the rectangular shape.

7. The display device of claim 4, wherein the first support pillar and each of the plurality of second support pillars has a cylindrical shape.

8. The display device of claim 7, wherein the first support pillar and each of the plurality of second support pillars has a diameter of about 0.5 mm to about 1.5 mm.

9. The display device of claim 4, wherein the connection part comprises:
a first connection part extending in the first direction; and
a second connection part extending in the second direction and crossing the first connection part,
wherein the first support pillar is configured to be connected to a crossing point of the first and second connection parts, and the plurality of second support pillars are respectively configured to be connected to ends of each of the first and second connection parts.

10. The display device of claim 4, further comprising a plurality of adhesion members respectively on a plurality of first holes defined in the light source substrate,
wherein a lower portion of the second support pillar is configured to be inserted into a corresponding first hole of the plurality of first holes and is configured to be connected to the light source substrate by a respective one of the plurality of adhesion members.

11. The display device of claim 10, wherein the second support pillar comprises:
a first portion; and
a second portion protruding from the first portion downward in the third direction and configured to be inserted into the corresponding first hole.

12. The display device of claim 11, wherein, when viewed in the plane, the first portion is greater in diameter than the corresponding first hole, and
the second portion is smaller in diameter than the corresponding first hole.

13. The display device of claim 11, further comprising a reflection sheet on the light source substrate, the reflection sheet comprising a plurality of second holes into which the plurality of light source units are configured to be respectively inserted, and a plurality of third holes,
wherein the second portion is configured to pass through a corresponding third hole of the plurality of third holes and be inserted into the corresponding first hole.

14. The display device of claim 13, wherein each adhesion member of the plurality of adhesion members is configured to cover a region of the reflection sheet adjacent to the corresponding third hole and a lower portion of the corresponding first portion.

15. The display device of claim 5, wherein the connection part comprises:
a first connection part extending from a central portion of a triangular shape to a first vertex of the triangular shape;
a second connection part extending from the central portion to a second vertex of the triangular shape; and
a third connection part extending from the central portion to a third vertex of the triangular shape,
wherein the first support pillar is at the central portion and is configured to be connected to the first, second, and third connection parts, and
the plurality of second support pillars are respectively at the first, second, and third vertexes and configured to be respectively connected to the first, second, and third connection parts.

16. A display device comprising:
a display panel;
a light source substrate below the display panel;
a plurality of light source units on the light source substrate;
an optical member between the display panel and the light source substrate; and
a plurality of support members between the optical member and the light source substrate,
wherein each of the plurality of support members comprises:
a plurality of support pillars configured to support the optical member; and
a plurality of connection parts configured to connect the plurality of support pillars to each other,
wherein a lower portion of each of the plurality of support pillars is configured to be inserted into a corresponding first hole of a plurality of first holes defined in the light source substrate.

17. The display device of claim 16, wherein, the display panel lies in a plane defined by a first direction and a second direction crossing the first direction, and
when viewed in the plane, the plurality of support pillars are respectively at vertexes of a rectangular shape, and
the plurality of connection parts are respectively on four sides of the rectangular shape.

18. The display device of claim 16, wherein, the display panel lies in a plane defined by a first direction and a second direction crossing the first direction, and
when viewed in the plane, the plurality of support pillars are respectively at vertexes of a triangular shape, and
the plurality of connection parts are respectively on three sides of the triangular shape.

19. The display device of claim 16, wherein the plurality of connection parts comprises:
a first connection part extending in a first direction; and
a second connection part extending in a second direction crossing the first direction, the second connection part crossing the first connection part,
wherein the plurality of support pillars are configured to be respectively connected to ends of each of the first and second connection parts.

20. The display device of claim 16, wherein the plurality of support pillars are respectively at vertexes of a triangular shape, and
connection parts of the plurality of connection parts extend from a central portion of the triangular shape toward the vertexes and are configured to be connected to the plurality of support pillars, respectively.
